(19) United States
(12) Patent Application Publication
(10) Pub. No.: US 2007/0104528 A1
(43) Pub. Date: May 10, 2007

(54) Paper feeding device

(75) Inventor: Ming Kuan Qian, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, Taoyuan (TW)

(21) Appl. No.: 11/557,075

(22) Filed: Nov. 6, 2006

(30) Foreign Application Priority Data
Nov. 8, 2005 (TW) TW94139119

(51) Int. Cl. B41J 13/10

(52) U.S. Cl. 400/624

(57) ABSTRACT

The invention provides a paper feeding device. The paper feeding device comprises a paper container and a paper-transmitting mechanism. The paper container comprises a first connecting portion. The paper-transmitting mechanism comprises a second connecting portion. The second connecting portion movably connected with the first connecting portion which makes the paper-transmitting mechanism keeping a constant angle to the carrying surface during a paper-feeding process.

### BACKGROUND OF THE INVENTION

1. Field of the Invention

The present invention relates to a paper feeding device, and in particular relates to a paper feeding device in a copy machine or a printer etc.

2. Description of the Related Art

FIG. 1 shows that a conventional paper feeding device 10 comprises a paper container 11 and a paper-transmitting mechanism 12. The paper-transmitting mechanism 12 comprises an axle 121 and a roller 122. The paper-transmitting mechanism 12 pivots on the axle 121. The roller 122 rotates to transmit paper 20. Moreover, a line L between the axle 121 and the roller 122 and paper 20 form an included angle θ. Compare FIG. 1 with FIG. 2, the amount of paper 20 gradually decreases, thus, the paper-transmitting mechanism 12 pivots on the axle 121 and the included angle θ increases gradually, causing the position of the paper-transmitting mechanism 12 relative to the paper to change. Because the direction of a force exerted to each piece of paper by the paper-transmitting mechanism changes due to the variation in the position of the roller, the magnitude of the force changes too, paper jams and multi-feeding may occur in the paper feeding device 10 when a printer or a copy machine works.

### BRIEF SUMMARY OF INVENTION

A detailed description is given in the following embodiments with reference to the accompanying drawings. The invention provides a paper feeding device. The paper feeding device comprises a paper container and a paper-transmitting mechanism. The paper container comprises a first connecting portion. The paper-transmitting mechanism comprises a second connecting portion. The first connecting portion and the second connecting portion can connected to keep the paper transmitting mechanism moving along a direction, whether increasing or decreasing the mount of paper in the paper container, a fixed angle between the paper-transmitting mechanism and paper in the paper container always exists and the force exerted to each piece of the papers in the paper container is constant.

### BRIEF DESCRIPTION OF DRAWINGS

The present invention can be more fully understood by reading the subsequent detailed description and examples with references made to the accompanying drawings, wherein:

FIG. 1 is a schematic view of a conventional paper feeding device at full capacity;

FIG. 2 is a schematic view of a conventional paper feeding device having less paper than FIG. 1;

FIG. 3 is a schematic view of a paper feeding device of one embodiment of the invention;

FIG. 4A is a sectional cross view along 4-4 of FIG. 3;

FIG. 4B is a schematic view of a paper feeding device having less paper than FIG. 4A;

FIG. 5 is another embodiment of the invention; and

FIG. 6 is another embodiment of the invention.

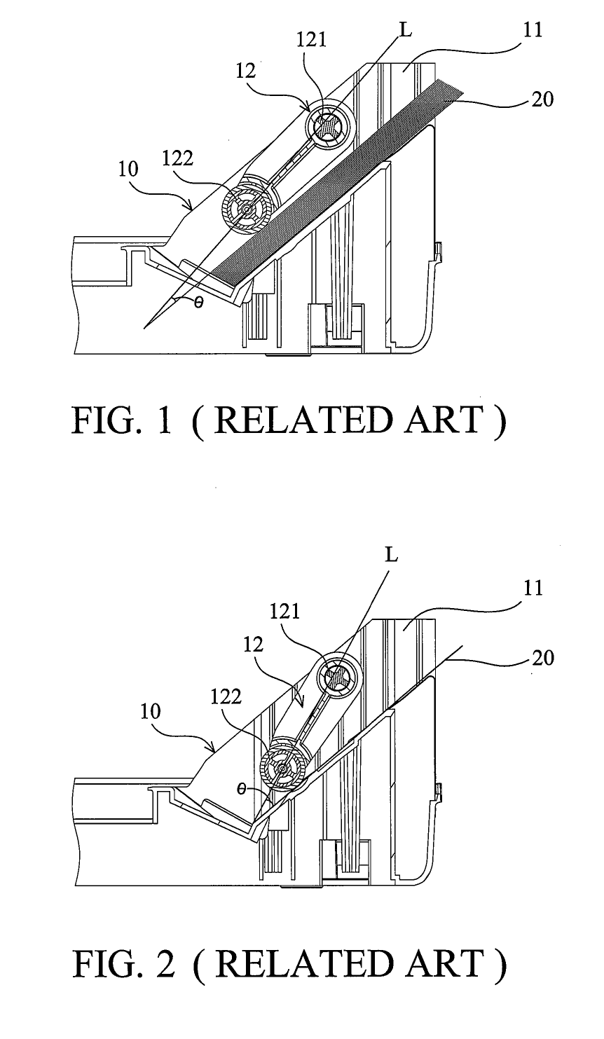

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims..

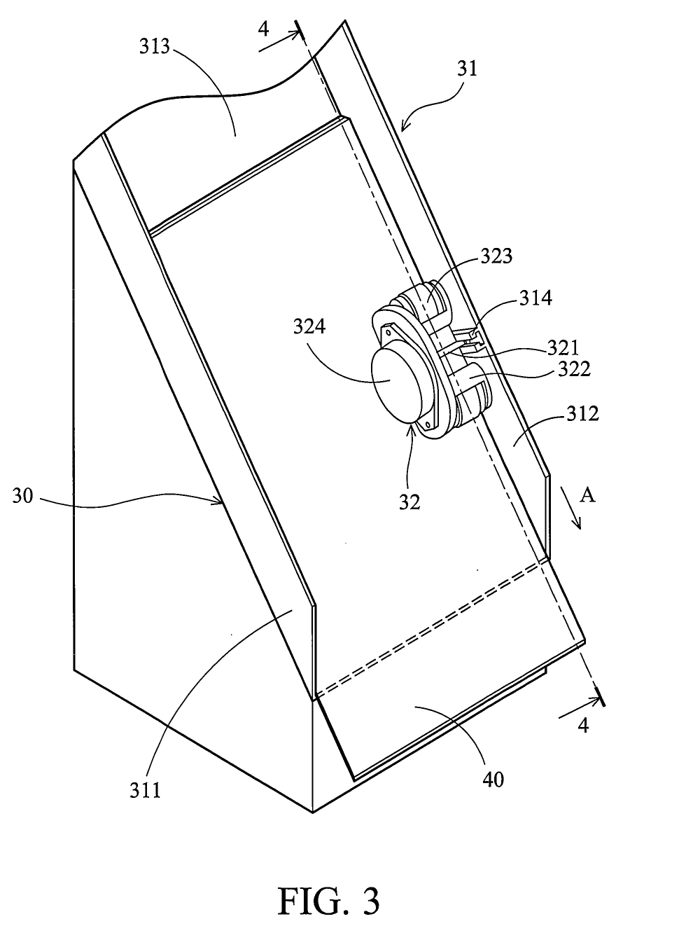

Referring to FIG. 3, the paper feeding device 30 comprises a paper container 31 and a paper-transmitting mechanism 32. The paper container 31 comprises two sides 311 and 312 and a carrying surface 313. The paper-transmitting mechanism 32 is installed on the side 312 to transmit paper 40 out of the paper container 31 along an arrow A.

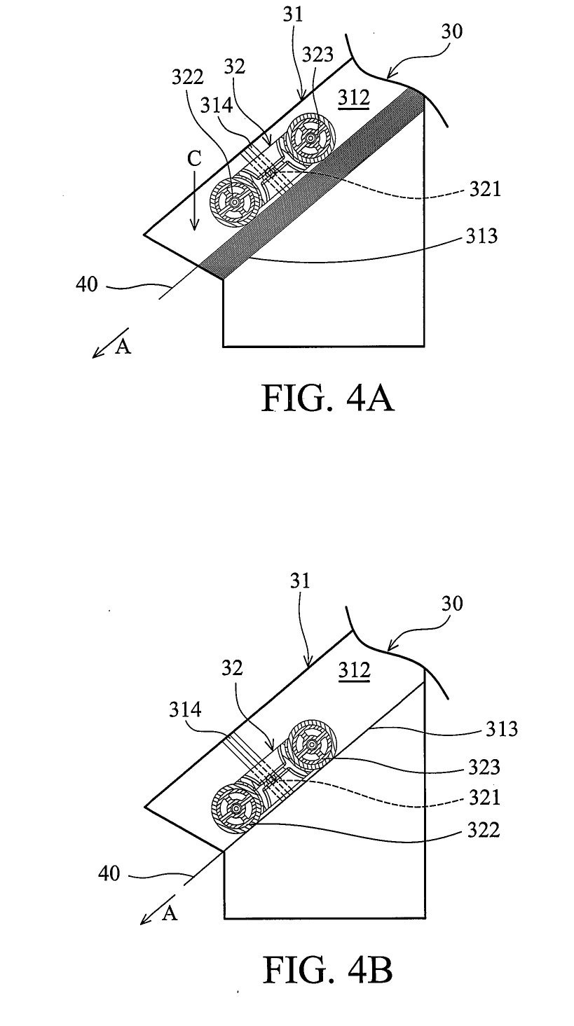

Referring to FIGS. 3 and 4A, FIG. 4A is a sectional cross section along 4-4 of FIG. 3. The paper container 31 comprises a first connecting portion 314 disposed on the side 312. In this embodiment, the first connecting portion 314 is a groove. The paper-transmitting mechanism 32 comprises a second connecting portion 321 movably connected to the first connecting portion 314. In this embodiment, the second connecting portion 321 is a protrusion, such as a T type protrusion. Moreover, the paper-transmitting mechanism 32 further comprises two rollers 322 and 323 and a driving device 324. In this embodiment, the driving device 324 is a motor for driving the rollers 322 and 323 to transmit paper 40. The paper-transmitting mechanism 32 and the carrying surface 313 form a fixed angle. In this embodiment, the fixed angle is 0 degree or 180 degree. Because paper 40 is placed flat on the carrying surface 313, the carrying surface 313 is parallel to the paper. The paper-transmitting mechanism 32 is parallel to the carrying surface 313 and paper 40 thereon. The amount of paper 40 on the carrying surface 313 decreases because paper 40 is transmitted out of the paper container 31, thereby, the paper-transmitting mechanism 32 descends along an arrow C.

FIG. 4B shows the paper-transmitting mechanism 32 gradually descending. As amount of decreases paper, the paper-transmitting mechanism 32 stays parallel to the paper 40 on the carrying surface 313. The paper-transmitting mechanism 32 and the paper 40 on the carrying surface 313 form a fixed angle, thus, the amount of force exerted on each piece of paper 40 by the paper-transmitting mechanism 32 is the same, thus, paper jams and muilt-feeding is prevented.

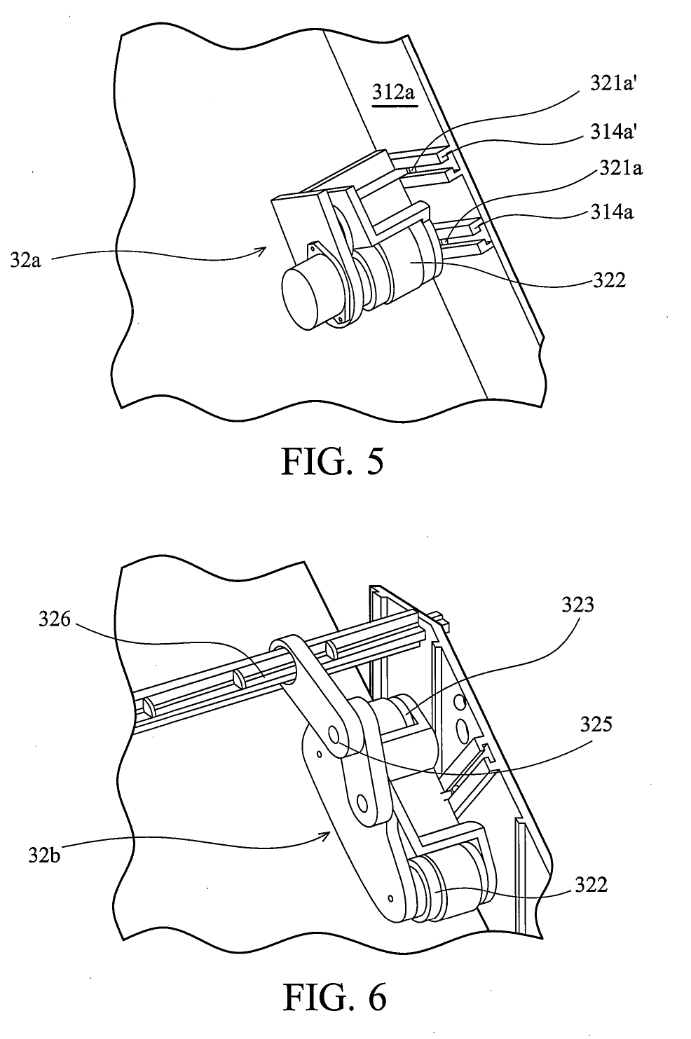

FIG. 5 shows another embodiment of a paper feeding device comprising the paper-transmitting mechanism 32a on the side 312a of the paper container 31. The paper container 31 comprises two first connecting portions 314a and 314a′. The paper-transmitting mechanism 32a comprises a roller 322 and two second connecting portions 321a and 321a′. The second connecting portions 321a and 321a′ are respectively and movably connected to the first connecting portions 314a and 314a′. This embodiment is approximately similar to the embodiment of FIG. 3, thus, description of identical elements is omitted.

FIG. 6 shows another embodiment of a paper feeding device, wherein the paper-transmitting mechanism 32b comprises two rollers 322 and 323, a transmitting mechanism 325, an axle and a driving device (not shown). The driving device drives the axle 326, and drives the transmitting mechanism 325, and then drives the rollers 322 and 323. The transmitting mechanism 325 may be a pulley or a gear drive. This embodiment is approximately similar to the embodiment of FIG. 3, thus, description of identical elements is omitted.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A paper feeding device, comprising:
a paper container comprising:
a carrying surface for carrying the paper; and
at least a first connecting portion; and
a paper-transmitting mechanism comprising:
at least a second connecting portion;
wherein the second connecting portion of the paper-transmitting mechanism is movably connected to the first connecting portion of the paper container; and
the paper-transmitting mechanism is always kept at a constant angle to the carrying surface during a paper-feeding process.

2. The paper feeding device as claimed in claim 1, wherein the paper-transmitting mechanism further comprises a roller and a driving device, the driving device drives the roller to roll for transmitting the paper.

3. The paper feeding device as claimed in claim 1, wherein the first connecting portion comprises a groove and the second connecting portion comprises a protrusion movably installed in the groove.

4. The paper feeding device as claimed in claim 2, wherein the driving device comprises a motor.

5. The paper feeding device as claimed in claim 2, wherein the paper-transmitting mechanism further comprises a transmitting mechanism, the driving device drives the roller via the transmitting mechanism for transmitting the paper.

6. The paper feeding device as claimed in claim 1, wherein the paper-transmitting mechanism is parallel to the carrying surface.

7. A printer device, comprising: the paper feeding device of claim 1.

8. A copy machine device, comprising: the paper feeding device of claim 1.
